(19) United States
(12) Patent Application Publication
(10) Pub. No.: US 2006/0064517 A1
(43) Pub. Date: Mar. 23, 2006

(54) Event-driven DMA controller

(75) Inventor: Brett D. Oliver, Tampa, FL (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Honeywell International Inc.

(21) Appl. No.: 10/948,368

(22) Filed: Sep. 23, 2004

(51) Int. Cl. G06F 13/28

(52) U.S. Cl. 710/22

(57) ABSTRACT

A DMA memory controller includes a program module operable to receive and execute instructions comprising instructions to perform multiple DMA transfers. The multiple DMA transfers are triggered by a hardware event. A hardware event monitor is operable to detect hardware events and to report the detected hardware events to the program module.

### FIELD OF THE INVENTION

The invention relates generally to computer memory management, and more specifically to an event-driven direct memory access (DMA) controller.

### BACKGROUND OF THE INVENTION

Computer systems have traditionally used memory to store executing programs and data, from the magnetic core memory of decades ago to today's modem high-speed synchronous dynamic random access memory (SDRAM). As memory technology evolved and memory became faster, and as a greater number of peripheral devices began to handle data stored in memory, processors needed to devote more and more of their time to memory management. Video cards, hard disk controllers, network interface cards, and a wide variety of other computer devices that are common today receive and store data from memory, placing a great demand on the memory's speed and bandwidth for transferring data.

Early computers required that all memory transfers be handled through a memory command executed in the processor. Because such a memory management scheme would place a great demand on a processor in a modem computer system, transfers to many hardware devices such as network interface cards, video cards, and hard disk controllers are performed via direct memory access (DMA) transfers. DMA enables a device to transfer data to or from memory without each element of data passing though the processor, reducing the demand placed on the processor in moving large blocks of data between memory and these various peripheral devices.

Traditionally, software executing on the processor recognizes a request or a need to move data between memory and a DMA peripheral device, and starts the transfer. The transfer then executes and completes directly, without passing each piece of data through the processor. The software is then notified when the DMA transfer is complete, receiving an indication that the data has been transferred between memory and the DMA peripheral device.

This method still requires use of software executing on the processor to initiate and oversee the DMA transfer, though, and places a demand on the processor. This demand can become significant in computer systems such as real-time communications systems where data arrives at regular intervals, which often requires that several groups of incoming data be moved based on some external event. For example, a user watching streaming video over a network connection may trigger many DMA transfers between the network interface card and memory, and between memory and the video card, per second. The DMA controller handles these transfers via software executing on the processor, with the aid of hardware-generated interrupts to request access to DMA transfer channels.

It is desired to reduce the processor's involvement in DMA transfers, making DMA memory transfers more efficient at reducing processor overhead for such memory transfers.

### SUMMARY OF THE INVENTION

A DMA memory controller includes a program module operable to receive and execute instructions comprising instructions to perform multiple DMA transfers. The multiple DMA transfers are triggered by a hardware event. A hardware event monitor is operable to detect hardware events and to report the detected hardware events to the program module

### BRIEF DESCRIPTION OF THE FIGURES

FIG. 1 shows a block diagram of a software programmable hardware event-driven direct memory access controller in a computerized system, consistent with an example embodiment of the present invention.

FIG. 2 shows a block diagram of a computerized image acquisition satellite; consistent with an example embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in various embodiments a system for controlling DMA memory transfers. A program module is operable to receive and execute instructions comprising instructions to perform multiple DMA transfers, which are triggered by a hardware event. A hardware event monitor is operable to detect hardware events and to report the detected hardware events to the program module, initiating the multiple DMA transfers

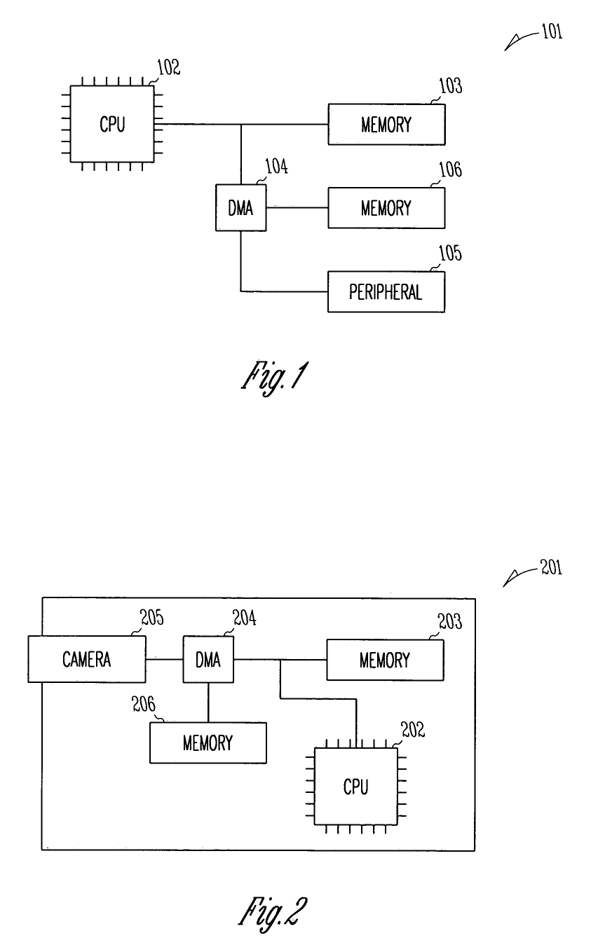

FIG. 1 shows generally at 101 a block diagram of a system including an event-driven DMA memory controller. A central processing unit 102 is coupled via a bus to memory 103, and to a direct memory access (DMA) memory controller 104. The DMA controller is coupled to one or more devices operable to conduct DMA transfers such as peripheral device 105. In further embodiments, the DMA controller 104 has at least some memory 106 either attached or as part of the DMA controller.

In operation, the DMA controller is operable to conduct memory transfers between the main system memory 103 and other DMA-aware devices such as peripheral device 105. For example, the peripheral device may be an interface to a video camera, which fills its buffers with captured video data and writes it directly to memory via DMA transfer coordinated through DMA controller 104. The present invention provides in some embodiments for event-driven programmed DMA transfer, such that a particular hardware event is detected by a hardware event monitor, and triggers multiple DMA transfers through execution of instructions provided to the DMA controller. The instructions or program data defining the multiple DMA transfers triggered by the hardware event are in some embodiments stored in memory within or local to the DMA controller, such as memory 106, while in other embodiments are stored in a portion of main system memory 103.

Consider as an example a computerized data acquisition device such as an image capture satellite, shown generally in FIG. 2. A camera 205 receives image data and stores it in a buffer until its buffers are nearing a full state. When a hardware event monitor detects that the buffers are nearly full, a hardware event is communicated to the DMA controller 204. The DMA controller 204 receives the hardware event data, and loads program instructions from memory 206 corresponding to the detected hardware event. In this example, it loads instructions to execute multiple memory transfers directly from the camera 205 to the main system memory 203.

The direct memory transfer saves time over a traditional memory transfer coordinated by the CPU 202, in that it doesn't require CPU intervention or software control to execute the memory transfer. The CPU is therefore free to use its computing power to perform other functions while the direct memory transfer is initiated. In a typical prior art system employing DMA components, the DMA controller receives DMA instructions from software executing on the CPU, and reports completion of the DMA transfer to the software upon DMA transfer completion. The present invention provides additional efficiency over a traditional direct memory access transfer in that a hardware event detected via a hardware event monitor initiates more than one unit of memory transfer at a time via use of a program or instructions provided to the DMA controller. The hardware event monitor in various embodiments detects events such as a buffer fill state, a timing signal, or other such events.

Various embodiments of the present invention still notify program software executing on a CPU of DMA transfer completion, but do not require the software to initiate the transfer or to coordinate multiple transfers where large blocks of data must be transferred. In some further embodiments, each hardware event detected results in execution of specific instructions in the DMA controller, such as where instructions specific to the hardware event are loaded from a programmed memory or flash memory storage to direct transfer to a specific, predetermined location in the main system memory. For example, a system with multiple sensors buffering data would generate a different hardware event for each sensor as each specific sensor's buffer filled, and the data stored in each sensor would trigger different DMA transfer instructions to move the data from each specific sensor to different locations in the main system memory.

The software configured, hardware triggered DMA transfer system and method described herein therefore is capable of providing more efficient memory transfer in many environments than traditional DMA controllers. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A DMA memory controller, comprising:
a program module, operable to receive and execute instructions comprising instructions to perform multiple DMA transfers, the multiple DMA transfers triggered by a hardware event; and
a hardware event monitor, operable to detect hardware events and to report the detected hardware events to the program module.

2. The DMA memory controller of claim 1, further comprising a memory, the memory operable to store DMA program module instructions.

3. The DMA memory controller of claim 1, wherein multiple DMA transfers are triggered by a single hardware event.

4. The DMA memory controller of claim 1, wherein the monitored hardware events include a buffer capacity monitor.

5. The DMA memory controller of claim 1, wherein the monitored hardware events include video data capture.

6. The DMA memory controller of claim 1, wherein the monitored hardware events include biomedical instrument data capture.

7. A method of communicating data with a memory, comprising:
detecting a hardware event via a hardware event monitor;
receiving instructions to perform multiple DMA memory transfers; and
executing said received instructions upon detection of a hardware event to perform the multiple DMA memory transfers.

8. The method of claim 1, further comprising storing the instructions to perform multiple DMA memory transfers in memory.

9. The method of claim 1, wherein multiple DMA transfers are triggered by a single hardware event.

10. The method of claim 1, wherein the detected hardware events include a buffer capacity monitor.

11. The method of claim 1, wherein the detected hardware events include video data capture.

12. The method of claim 1, wherein the detected hardware events include biomedical instrument data capture.

13. A computerized data acquisition device, comprising:
a data acquisition element;
a memory;
a program module, operable to receive and execute instructions comprising instructions to perform multiple DMA memory transfers, the multiple DMA memory transfers triggered by a hardware event; and
a hardware event monitor, operable to detect hardware events and to report the detected hardware events to the program module.

14. The computerized data acquisition device of claim 13, wherein the memory is operable to store program module DMA instructions.

15. The computerized data acquisition device of claim 13, wherein multiple DMA transfers are triggered by a single hardware event.

16. The computerized data acquisition device of claim 13, wherein the monitored hardware events include a buffer capacity monitor.

17. The computerized data acquisition device of claim 13, wherein the monitored hardware events include video data capture.

18. The computerized data acquisition device of claim 13, wherein the monitored hardware events include biomedical instrument data capture.

19. The computerized data acquisition device of claim 13, wherein the data acquisition element comprises at least one of a biomedical instrument, a camera, or a weather instrument.
